(19) United States
(12) Patent Application Publication
(10) Pub. No.: US 2026/0342466 A1
(43) Pub. Date: Oct. 29, 2026

(54) COMMUNICATION DEVICE, COMMUNICATION SYSTEM, AND TIME SYNCHRONIZATION METHOD

(71) Applicant: DENSO CORPORATION, Kariya-city (JP)

(72) Inventors: Takuto YOSHIDA, Kariya-shi (JP); Mao YAMAUCHI, Kariya-shi (JP)

(21) Appl. No.: 19/548,117

(22) Filed: Feb. 24, 2026

(30) Foreign Application Priority Data
Feb. 28, 2025 (JP) 2025-031442

(51) Int. Cl. H04J 3/06; B60R 16/023

(52) U.S. Cl. CPC H04J 3/0667; B60R 16/023

(57) ABSTRACT

A communication device in a plurality of nodes connected to an in-vehicle communication line comprises: a controller configured to output a first time synchronization frame; and a transceiver configured to transmit the first time synchronization frame output from the controller to the in-vehicle communication line in a physical layer collision avoidance manner, and notify the controller that the first time synchronization frame has been transmitted.

### CROSS REFERENCE TO RELATED APPLICATION

The present application claims the benefit of priority from Japanese Patent Application No. 2025-031442 filed on Feb. 28, 2025. The entire disclosure of the above application is incorporated herein by reference.

### TECHNICAL FIELD

The present disclosure relates to a communication technology via an in-vehicle communication line.

### BACKGROUND

In an example, a network controller is one of multiple nodes of a 10BASE-T1S network, and includes a microcontroller unit (MCU) and a physical layer (PHY) circuit. In the 10BASE-T1S network, access is controlled in a Physical Layer Level Collision Avoidance (PLCA) manner, and transmission opportunities are determined by a round-robin system. Therefore, in a case of performing the time synchronization in the 10BASE-T1S network, a time when the PHY circuit transmits a time synchronization frame (that is, a time stamp added to the time synchronization frame) to the network may be later than a time when the MCU transmits the time synchronization frame to the PHY circuit.

Therefore, in the network controller described above, the PHY circuit includes a circuit that detects the synchronization time frame and a circuit that provides the time stamp, and applies the time stamp to the synchronization time frame.

### SUMMARY

A communication device in a plurality of nodes connected to an in-vehicle communication line comprises: a controller configured to output a first time synchronization frame; and a transceiver configured to transmit the first time synchronization frame output from the controller to the in-vehicle communication line in a physical layer collision avoidance manner, and notify the controller that the first time synchronization frame has been transmitted.

### BRIEF DESCRIPTION OF DRAWINGS

FIG. 1 is a diagram showing an example of a configuration of an in-vehicle communication system according to a first embodiment.

FIG. 2 is a diagram showing another example of a configuration of an in-vehicle communication system according to the first embodiment.

FIG. 3 is a diagram showing a data flow of a PLCA in an in-vehicle communication system according to the first embodiment.

FIG. 4 is a block diagram showing functions of a controller and a transceiver in a node of the in-vehicle communication system according to the first embodiment.

FIG. 5 is a diagram showing a Sync/Follow-up sequence in the in-vehicle communication system according to the first embodiment.

FIG. 6 is a diagram showing a Pdelay Request/Pdelay Response sequence in the in-vehicle communication system according to the first embodiment.

FIG. 7 is a block diagram showing functions of the controller and the transceiver in the node of the in-vehicle communication system according to a second embodiment.

FIG. 8 is a diagram showing a Sync/Follow-up sequence in the in-vehicle communication system according to the second embodiment.

### DETAILED DESCRIPTION

The PHY circuit of the network controller described above includes a circuit that detects a synchronization time frame and a circuit that provides a time stamp. Therefore, the circuit configuration is complex. Further, the cost of network controllers increases.

One aspect of the present disclosure provides a technology for improving time synchronization accuracy in an in-vehicle communication line by a simple circuit configuration.

According to an aspect of the present disclosure, a communication device in a plurality of nodes connected to an in-vehicle communication line includes a controller and a transceiver. The controller outputs the first time synchronization frame. The transceiver transmits the first time synchronization frame output from the controller to the in-vehicle communication line in a Physical Field Collision Avoidance manner, and notifies the controller that the first time synchronization frame has been transmitted.

According to the communication device of the present disclosure, the transceiver notifies the controller that the transceiver has transmitted the first time synchronization frame. Therefore, the controller can detect the time when the first time synchronization frame is actually transmitted to the in-vehicle communication line. The notification that the transceiver has transmitted the first time synchronization frame to the controller can be implemented by a simple circuit. Accordingly, by adding a simple circuit to the transceiver, it is possible to improve the time synchronization accuracy between nodes of the in-vehicle communication line.

According to another example of the present disclosure, a time synchronization method is executed by a transceiver of a communication device in a plurality of nodes connected to an in-vehicle communication line. The time synchronization method receives a time synchronization frame from a controller of the communication device, transmits the time synchronization frame to the in-vehicle communication line in a Physical Layer Collision Avoidance manner, and notifies the controller that the time synchronization frame has been transmitted.

This achieves the same effects as achieved by the communication device described above.

According to another aspect of the present disclosure, a communication system includes a master node and a slave node connected to an in-vehicle communication line. The master node includes a controller and a transceiver. The controller (i) outputs the first time synchronization frame to the transceiver, (ii) acquires a time stamp in response to notification that the transceiver has transmitted the first time synchronization frame, and (iii) outputs the second time synchronization frame storing the time stamp to the transceiver. The transceiver (i) transmits the first time synchronization frame output from the controller to a slave node via an in-vehicle communication line in a Physical Layer Collision Avoidance manner, and (ii) notifies the controller that the first time synchronization frame has been transmitted, and (iii) transmits a second time synchronization frame output from the controller to the slave node via the in-vehicle communication line. The slave node synchronizes the time of the slave node with the time of the master node based on a time when the first time synchronization frame is received and a time stamp of the second time synchronization frame.

According to the communication system described above, the slave node can acquire the reception time when the slave node received the first time synchronization frame and the transmission time when the first time synchronization frame was transmitted to the in-vehicle communication line. Then, the slave node can calculate the time offset with respect to the master node based on the reception time and the transmission time, and synchronize the time with the master node.

### 1. FIRST EMBODIMENT

### 1-1. Configuration

### 1-1-1. Overall Configuration

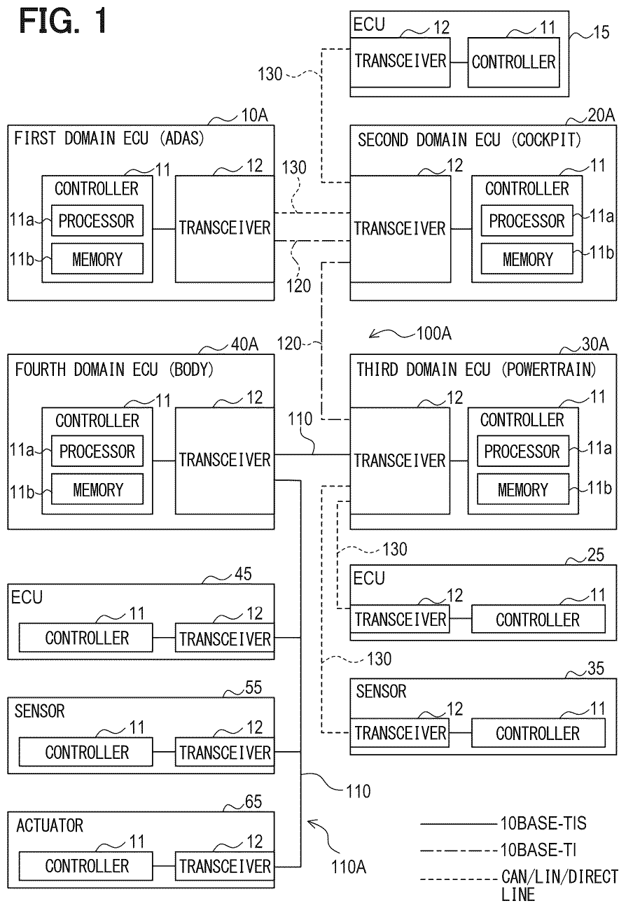

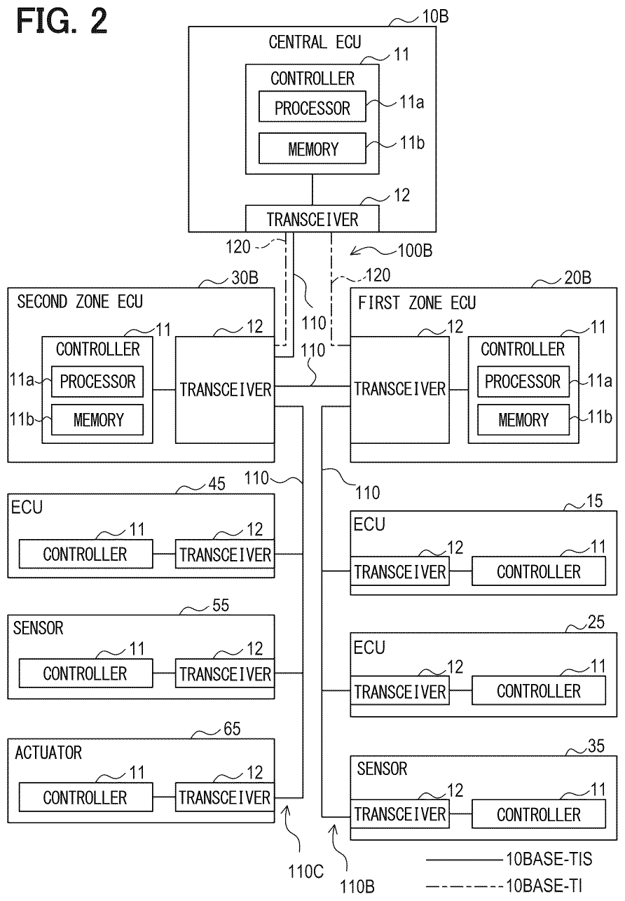

A configuration of in-vehicle communication systems 100A and 100B according to the present embodiment will be described with reference to FIG. 1 and FIG. 2. The in-vehicle communication system 100A is an example of a communication system mounted on a vehicle, and the in-vehicle communication system 100B is another example of a communication system mounted on the vehicle.

The in-vehicle communication system 100A includes multiple nodes, a first communication line 110, a second communication line 120, and a third communication line 130. The multiple nodes include a first domain electronic control unit (ECU) 10A, a second domain ECU 20A, a third domain ECU 30A, a fourth domain ECU 40A, and ECUs 15, 25, 45, sensors 35, 55, and an actuator 65.

In the in-vehicle communication system 100A, the ECUs, sensors, actuators, and the like mounted on the vehicle are grouped by functional area. The first, second, third, and fourth domain ECUs 10A, 20A, 30A, and 40A integrally control the ECUs, the sensors, the actuator, and the like belonging to a specific functional area. For example, the first domain ECU 10A controls processes of cameras, radars, and the like belonging to the advanced driving assistance system (ADAS) domain. The second domain ECU 20A controls processes of digital meters, infotainment systems, driver monitoring systems, and the like belonging to the cockpit domain. The third domain ECU 30A controls processes of engines, transmissions, motors, and the like belonging to the powertrain domain. The fourth domain ECU 40A controls processes of lights, doors, air conditioning, and the like belonging to the body domain.

The first communication line 110 is an Ethernet (registered trademark) communication line that supports multi-drop connection in addition to point-to-point connection. Specifically, the first communication line 110 follows the protocol of 10BASE-T1S. The 10BASE-T1S is standardized by IEEE 802.3cg. The IEEE is a registered trademark.

The second communication line 120 is a communication line capable of only point-to-point connection. Specifically, the second communication line 120 follows the 10BASE-T1 protocol. The 10BASE-T1 is standardized by IEEE 802.3cg. The third communication line 130 follows a protocol other than Ethernet. For example, the third communication line 130 follows a protocol such as Controller Area Network (CAN) or Local Interconnect Network (LIN). The CAN and LIN are registered trademarks or a direct line.

The first domain ECU 10A is connected to the second domain ECU 20A via the second communication line 120 and the third communication line 130. The second domain ECU 20A is connected to the third domain ECU 30A via the second communication line 120. The second domain ECU 20A is connected to the ECU 15 via the third communication line 130. The third domain ECU 30A is connected to the fourth domain ECU 40A via the first communication line 110. The third domain ECU 30A is connected to each of the ECU 25 and the sensor 35 via the third communication line 130. The fourth domain ECU 40A is connected to the ECU 45, the sensor 55, and the actuator 65 by a bus via the first communication line 110. The fourth domain ECU 40A, the ECU 45, the sensor 55, the actuator 65, and the first communication line 110 constitute a bus type network 110A.

The in-vehicle communication system 100B includes multiple nodes, the first communication line 110, and the second communication line 120. The multiple nodes include a central ECU 10B, a first zone ECU 20B, a second zone ECU 30B, the ECUs 15, 25, 45, the sensors 35, 55, and the actuator 65.

In the in-vehicle communication system 100B, the vehicle is divided into multiple zones, and the vehicle is managed in zone units. The first zone ECU 20B controls the ECUs, the sensors, the actuators, and the like placed in the first zone. The second zone ECU 30B controls the ECUs, the sensors, the actuators, and the like placed in the second zone. The central ECU 10B centrally manages the entire vehicle in cooperation with the first zone ECU 20B and the second zone ECU 30B.

The first zone ECU 20B is connected to the central ECU 10B via the second communication line 120, and is connected to the second zone ECU 30B via the first communication line 110. The first zone ECU 20B is connected to the ECU 15, the ECU 25, and the sensor 35 by the bus via the first communication line 110. The second zone ECU 30B is connected to the central ECU 10B via the first communication line 110 and the second communication line 120. The second zone ECU 30B is connected to the ECU 45, the sensor 55, and the actuator 65 by the bus via and the first communication line 110. The first zone ECU 20B, the ECU 15, the ECU 25, the sensor 35, and the first communication line 110 constitute a bus type network 110B. The second zone ECU 30B, the ECU 45, the sensor 55, the actuator 65, and the first communication line 110 constitute a bus type network 110C. In the present embodiment, the first communication line 110 corresponds to an in-vehicle communication line of the present disclosure.

Each node of the in-vehicle communication systems 100A and 100B includes a controller 11, and a transceiver 12. The controller 11 includes a processor 11a and a memory 11b. The processor 11a executes various programs stored in the memory 11b to implement various functions. The memory 11b includes, for example, a random access memory (RAM) and a flash memory. The RAM is used as a working area during the processor 11a executing processing. The flash memory stores programs.

The transceiver 12 is an interface implemented in the physical layer of OSI reference model, that is, PHY. The transceiver 12 is directly connected to any one of the first, second, and third communication lines 110, 120, and 130. The controller 11 is connected to the transceiver 12 by a signal line, and is connected to any of the first, second, and third communication lines 110, 120, and 130 via the transceiver 12.

The transceiver 12 communicates with the other transceivers 12 via any of the first, second, and third communication lines 110, 120, and 130. A physical layer collision avoidance (PLCA) is installed in the transceivers 12 of the bus type networks 110A, 110B, and 110C. In the PLCA, a schedule is controlled to avoid collisions. The transceiver 12 transmits the Ethernet frame to the first communication line 110 in accordance with the PLCA in the bus type networks 110A, 110B, and 110C. In the PLCA, the transmission opportunity of each node is determined in a round-robin manner. The round-robin manner is a method of sequentially utilizing resources.

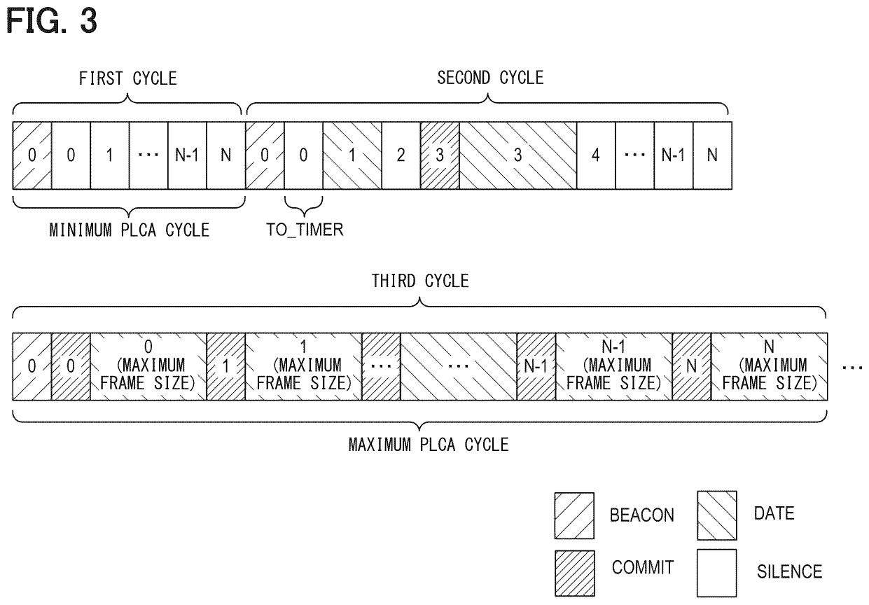

FIG. 3 shows a data flow of the PLCA in a bus type network including N+1 nodes. One of the N+1 nodes becomes a coordinator, and the remaining nodes become followers. The coordinator is assigned an ID=0 and manages the communication opportunities of each node. The follower is assigned ID=1 to N, and transmits the frame to the transmission opportunity assigned to the coordinator. The coordinator transmits a BEACON to reset the TO_TIMER (timer) and start the PLCA cycle. The BEACON is a synchronization signal to all nodes.

In the first cycle, the N+1 nodes skip the frame without transmitting it to each transmission opportunity. Therefore, the first cycle is the minimum PLCA cycle. In the second cycle, after the timer is reset, the node “1” transmits the frame, and the node “2” skips it. The node “3” transmits the frame after transmitting a COMMIT signal. The node transmits the COMMIT signal when the transmission opportunity has been obtained and the frame transmission cannot start immediately. Thereby, it may be possible to stop the timer of the other node and make the other node wait. Nodes “4” to “N” are skipped. In the third cycle, after the timer is reset, each of the N+1 nodes transmits the maximum size frame after transmitting the COMMIT signal. Accordingly, the third cycle is the maximum PLCA cycle.

In another embodiment, the in-vehicle communication system 100A may not include four domain ECUs, and may include one, two, three, or five or more domain ECUs. Each domain ECU may be connected to any number of ECUs and/or sensors and/or actuators. Further, the in-vehicle communication system 100A may not include the second communication line 120 and/or the third communication line 130. The in-vehicle communication system 100B may not include two zone ECUs, and may include one zone ECU or three or more zone ECUs. In the in-vehicle communication system 100B, one zone ECU and a central ECU may be integrated. Any number of ECUs and/or sensors and/or actuators may be connected to each zone ECU. Further, the in-vehicle communication system 100B may not include the second communication line 120, or may additionally include a third communication line such as CAN or LIN.

### 1-1-2. Functional Configuration

When multiple nodes of a network operate together, it is necessary that all nodes share an accurate time. In the in-vehicle communication systems 100A and 100B, the time is synchronized between nodes connected by the first communication line 110, the second communication line 120, or the third communication line 130.

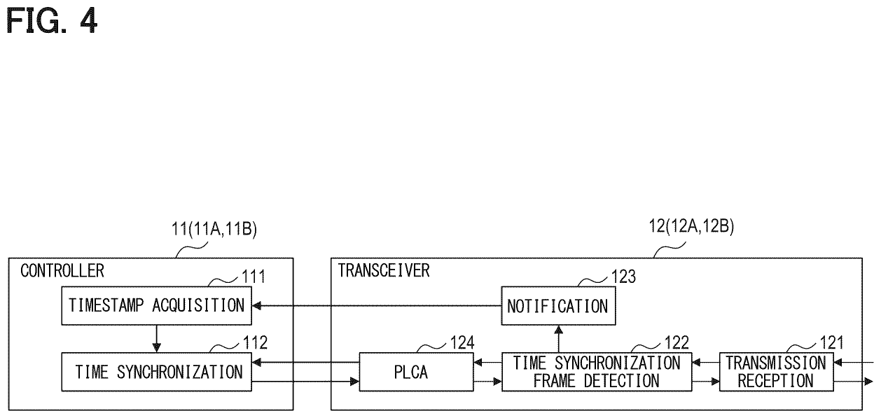

Functions related to time synchronization of the controller 11 and the transceiver 12 will be described with reference to FIG. 4. The controller 11 includes a time stamp acquisition unit 111 and a time synchronization unit 112. The transceiver 12 includes a transmission reception unit 121, a time synchronization frame detection unit 122, a notification unit 123, and a PLCA unit 124.

The time synchronization unit 112 generates a first time synchronization frame and outputs it to the transceiver 12. The PLCA unit 124 outputs the first time synchronization frame received from the time synchronization unit 112 to the time synchronization frame detection unit 122 at the transmission opportunity assigned to the own node. When detecting the first time synchronization frame, the time synchronization frame detection unit 122 notifies the notification unit 123 that the first time synchronization frame has been detected, and outputs the first time synchronization frame to the transmission reception unit 121. The transmission reception unit 121 transmits the first time synchronization frame to the first communication line 110, the second communication line 120, or the third communication line 130. The notification unit 123 notifies the controller 11 that the first time synchronization frame has been transmitted.

The time stamp acquisition unit 111 acquires the time stamp in response to notification that the first time synchronization frame has been transmitted by the notification unit 123. This time stamp matches the actual transmission time of the first time synchronization frame and is used for time synchronization of the slave node. The time stamp acquisition unit 111 transmits the acquired time stamp to the time synchronization unit 112. The time synchronization unit 112 outputs the second time synchronization frame storing the time stamp to the transceiver 12. The PLCA unit 124 receives the second time synchronization frame from the time synchronization unit 112 and outputs the second time synchronization frame to the transmission reception unit 121 via the time synchronization frame detection unit 122. The transmission reception unit 121 transmits the second time synchronization frame to the first communication line 110, the second communication line 120, or the third communication line 130.

Here, when the transceiver 12 transmits the first time synchronization frame in the PLCA manner, a difference between the time t1 and the time t1′ may occur due to the waiting time of the transmitter opportunity. The time t1 is a time when the controller 11 transmits the first time synchronization frame to the transceiver 12. The time t1′ is a time when the transceiver 12 transmits the first time synchronization frame to the first communication line 110.

Therefore, when the time synchronization unit 112 transmits the second time synchronization frame storing the time stamp of time t1 to the first communication line 110 via the transceiver 12, the time synchronization accuracy between the nodes may decrease. On the other hand, the transceiver 12 includes the notification unit 123. The notification unit 123 may include a simple circuit, and notifies the controller 11 that the first time synchronization frame has been transmitted. Thereby, the time stamp acquisition unit 111 can acquire the time stamp indicating the time t1′.

The transceiver 12 of the node not connected to the bus type networks 110A, 110B, and 110C may not include the time synchronization frame detection unit 122, the notification unit 123, and the PLCA unit 124.

### 1-2. Time Synchronization Process

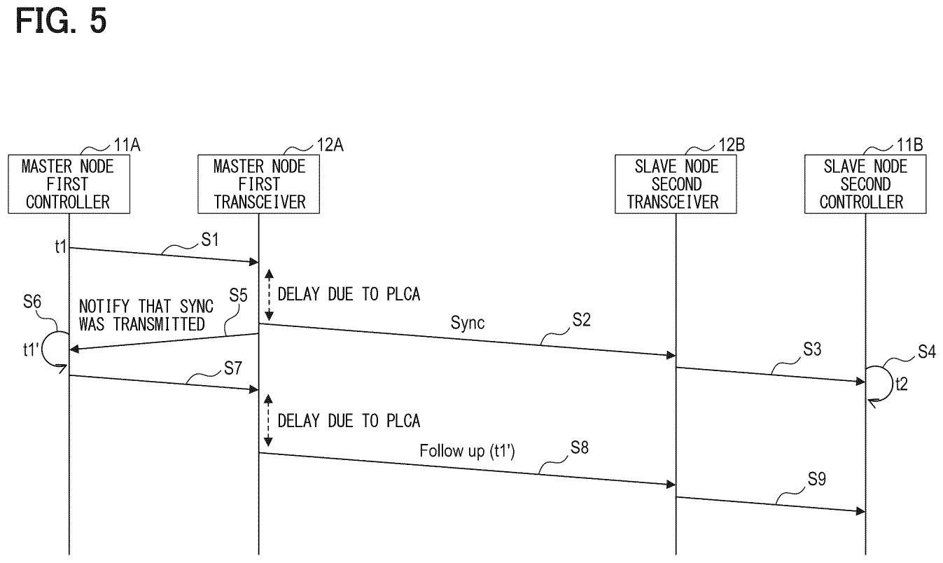

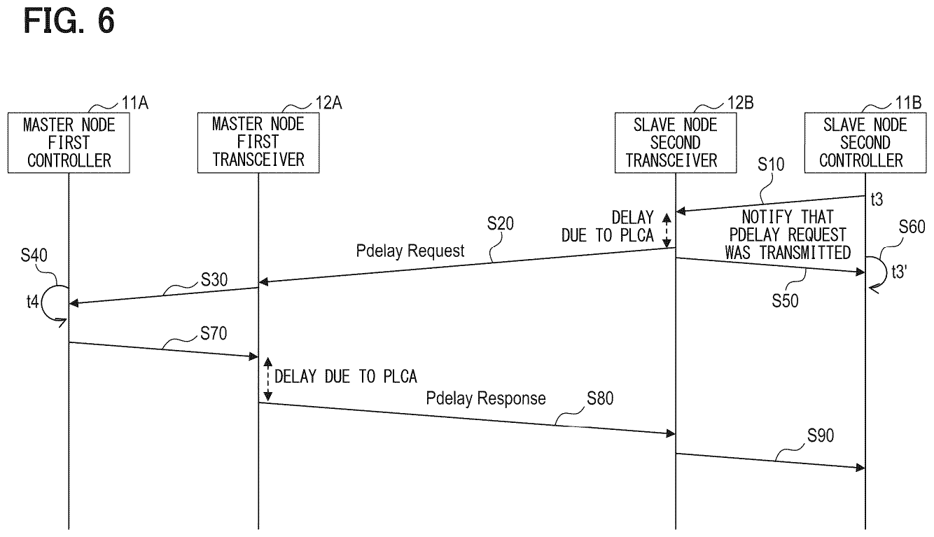

The time synchronization process executed by the node of the bus type network 110A will be described with reference to FIGS. 5 and 6. The current time synchronization process can also be applied to the nodes of the bus type networks 110B and 110C. One of the multiple nodes in the bus type network 110A serves as a master node, and the other node serves as a slave node. The slave node adjusts its own time to match that of the master node. The coordinator of the PLCA may be the master node, or the follower may be the master node. Hereinafter, the controller 11 and the transceiver 12 of the master node may be referred to as a first controller 11A and a first transceiver 12A, and the controller 11 and the transceiver 12 of the slave node may be referred to as a second controller 11B and a second transceiver 12B.

First, the Sync/Follow-up sequence shown in FIG. 5 will be described. In S1, the time synchronization unit 112 of the first controller 11A transmits the Sync frame to the first transceiver 12A at time t1. The Sync frame is a time synchronization frame defined by the Precision Time Protocol.

In S2, the PLCA unit 124 of the first transceiver 12A transmits the Sync frame received from the first controller 11A to the first communication line 110 via the time synchronization frame detection unit 122 and the transmission reception unit 121 at the transmission opportunity of the PLCA (specifically, time t1′). The time t1′ is a time later than the time t1.

In S3, the transmission reception unit 121 of the second transceiver 12B receives the Sync frame via the first communication line 110. Then, the transmission reception unit 121 of the second transceiver 12B transmits the received Sync frame to the second controller 11B via the time synchronization frame detection unit 122 and the PLCA unit 124.

In S4, the time synchronization unit 112 of the second controller 11B receives the Sync frame at time t2 and records the time stamp at time t2. In S5, the notification unit 123 of the first transceiver 12A receives the notification that the Sync frame has been detected from the time synchronization frame detection unit 122, and notifies the first controller 11A that the Sync frame has been transmitted to the first communication line 110.

In S6, the time stamp acquisition unit 111 of the first controller 11A receives, from the notification unit 123, a notification that the Sync frame has been transmitted, acquires the time stamp of time t1′, and records the time stamp.

In S7, the time synchronization unit 112 of the first controller 11A generates the Follow-up frame storing the recorded time stamp, and transmits the Follow-up frame to the first transceiver 12A. The Follow-up frame is a time synchronization frame defined by the Precision Time Protocol.

In S8, the PLCA unit 124 of the first transceiver 12A transmits the Follow-up frame received from the first controller 11A to the first communication line 110 via the time synchronization frame detection unit 122 and the transmission reception unit 121 at the transmission opportunity of the PLCA.

In S9, the transmission reception unit 121 of the second transceiver 12B receives the Follow-up frame via the first communication line 110. Then, the transmission reception unit 121 of the second transceiver 12B transmits the received Follow-up frame to the second controller 11B via the time synchronization frame detection unit 122 and the PLCA unit 124. Thereby, the second controller 11B acquires the time t1′ and the time t2.

Next, a Path delay (Pdelay) Request/Pdelay Response sequence shown in FIG. 6 will be described. In S10, the time synchronization unit 112 of the second controller 11B transmits the Pdelay Request frame to the second transceiver 12B at time t3. The Pdelay Request frame is a time synchronization frame defined by the Precision Time Protocol.

In S20, the PLCA unit 124 of the second transceiver 12B transmits the Pdelay Request frame received from the second controller 11B to the first communication line 110 via the time synchronization frame detection unit 122 and the transmission reception unit 121 at a transmission opportunity (specifically, time t3′) of the PLCA. The time t3′ is a time later than the time t3.

In S30, the transmission reception unit 121 of the first transceiver 12A receives the Pdelay Request frame via the first communication line 110. Then, the transmission reception unit 121 of the first transceiver 12A transmits the received Pdelay Request frame to the first controller 11A via the time synchronization frame detection unit 122 and the PLCA unit 124.

In S40, the time synchronization unit 112 of the first controller 11A receives the Pdelay Request frame at time t4 and records the time stamp at time t4. In S50, when receiving the notification that the Pdelay Request frame have been detected from the time synchronization frame detection unit 122, the notification unit 123 of the second transceiver 12B notifies the second controller 11B that the Pdelay Request frame has been transmitted to the first communication line 110.

In S60, the time stamp acquisition unit 111 of the second controller 11B receives, from the notification unit 123, a notification that the Pdelay Request frame has been transmitted, acquires the time stamp of time t3′, and records the time stamp.

In S70, the time synchronization unit 112 of the first controller 11A generates the Pdelay Response frame storing the time stamp of the recorded time t4, and transmits the Pdelay Response frame to the first transceiver 12A. The Pdelay Response frame is a time synchronization frame defined by the Precision Time Protocol.

In S80, the PLCA unit 124 of the first transceiver 12A transmits the Pdelay Response frame received from the first controller 11A to the first communication line 110 via the time synchronization frame detection unit 122 and the transmission reception unit 121 at the transmission opportunity of the PLCA.

In S90, the transmission reception unit 121 of the second transceiver 12B receives the Pdelay Response frame via the first communication line 110. Then, the transmission reception unit 121 of the second transceiver 12B transmits the received Pdelay Response frame to the second controller 11B via the time synchronization frame detection unit 122 and the PLCA unit 124. Thereby, the second controller 11B acquires the time t3′ and the time t4 in addition to the time t1′ and the time t2.

The time synchronization unit 112 of the second controller 11B uses the times t1′, t2, t3′, and t4 to calculate a time offset Δt (that is, a time correction value) for matching with the time of the master node. An equation of (i) t2=t1′+Δt+ΔT and an equation of (ii) t4=t3′−Δt+ΔT are established. The ΔT is the transmission path delay. Based on these, Δt=((t2−t1′)−(t4−t3′))/2 and ΔT=((t2−t1′)+(t4−t3′))/2 are calculated. The time synchronization unit 112 of the second controller 11B corrects the time of the own node by the time offset Δt.

Here, the transmission path delay ΔT may be a predetermined fixed value. When the transmission path delay ΔT is a fixed value, the time offset Δt is calculated by Δt=t2−t1′−ΔT or Δt=t3′−t4+ΔT. Accordingly, in this case, the master node and the slave node may execute only the processes in S1 to S9 and may not execute the processes in S10 to S90. Alternatively, the master node and the slave node may execute only the processes in S10 to S90 and may not execute the processes in S1 to S9. In the present embodiment, the Sync frame and the Pdelay Response frame correspond to a first synchronization time frame of the present disclosure, and the Follow-up frame and the Pdelay Response frame correspond to a second synchronization time frame of the present disclosure.

### 1-4. Effects

According to the first embodiment described in detail above, the following effects are achieved.
(1) The notification unit 123 of the transceiver 12 notifies the controller 11 that the Sync frame or the Pdelay Response frame has been transmitted to the first communication line 110. Accordingly, the controller 11 can detect the time t1′ or the time t3′ at which the Sync frame or the Pdelay Response frame is actually transmitted to the first communication line 110. The notification unit 123 can be implemented by a simple circuit. Accordingly, by adding the simple circuit to the transceiver 12, it is possible to improve the time synchronization accuracy in the bus type networks 110A, 110B, and 110C.
(2) The controller 11 acquires the time stamp in response to the notification from the notification unit 123, and can detect the time t1′ or the time t3′ at which the Sync frame or the Pdelay Response frame is transmitted.
(3) The controller 11 of the master node transmits the Follow-up frame storing the time stamp of time t1′ to the first communication line 110 via the transceiver 12. The controller 11 of the slave node can acquire the time stamp from the received Follow-up frame, and synchronize the time with the master node based on the time stamp.
(4) The slave node can acquire the time t2 at which the slave node receives the Sync frame and the time t1′ at which the Sync frame is transmitted to the first communication line 110. Then, the slave node can calculate the time offset Δt with respect to the master node based on the times t1′ and t2, and synchronize the time with the master node.

### SECOND EMBODIMENT

### 2-1. Differences from First Embodiment

The basic configuration of second embodiment is similar to that of the first embodiment. Therefore, the difference therebetween will be mainly described below. Note that the same reference numerals as those in the first embodiment indicate the same configuration, and refer to the preceding descriptions.

In the first embodiment described above, the notification unit 123 of the transceiver 12 always notifies the controller 11 that the Sync frame or the Pdelay Response frame has been transmitted. On the other hand, the second embodiment differs from the first embodiment in that, when the predetermined condition is satisfied, the notification unit 123 of the transceiver 12 disables (i.e., stops) the notification to the controller 11, the notification indicating that the Sync frame or the Pdelay Response frame has been transmitted. The predetermined condition is that the maximum PLCA delay is equal to or less than the threshold.

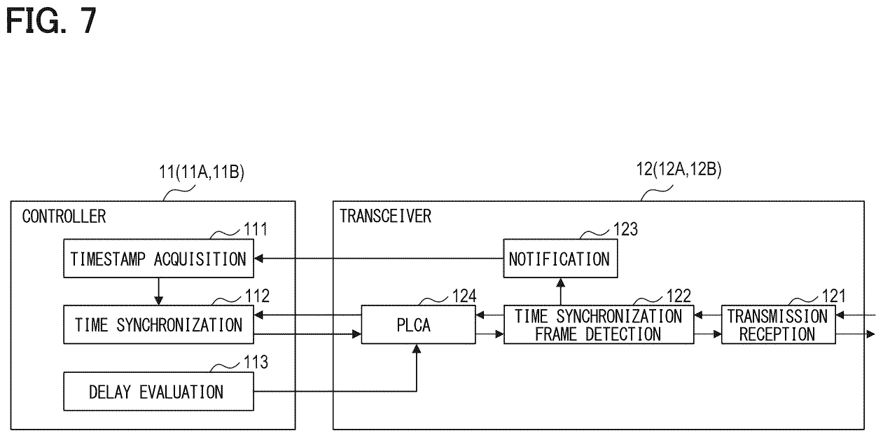

As shown in FIG. 7, the controller 11 includes a delay evaluation unit 113 in addition to the functional configuration of the controller 11 according to the first embodiment. The delay evaluation unit 113 calculates the maximum PLCA delay. The maximum PLCA delay is the maximum delay that can occur in the PLCA. Specifically, when the number of nodes of the network is N+1 and the master node is the node “N”, the maximum PLCA delay is a time from the time when the node “0” transmits the frame to the time when the node “N” transmits the frame. When the maximum PLCA delay occurs, the nodes “1” to “N−1” transmit the frame having the maximum size after transmitting the COMMIT signal.

When the number of nodes is small, the maximum PLCA delay may be less than the threshold. When the maximum PLCA delay is less than the set threshold, the difference between the time t1 and the time t1′ and the difference between the time t3 and the time t3′ are sufficiently small. Accordingly, even when the time offset Δt is calculated using the times t1 and t3 instead of the times t1′ and t3′, the decrease in the time synchronization accuracy is prevented. Therefore, when the maximum PLCA delay is less than the threshold, the notification unit 123 does not provide the notification to the controller 11.

### 2-2. Process

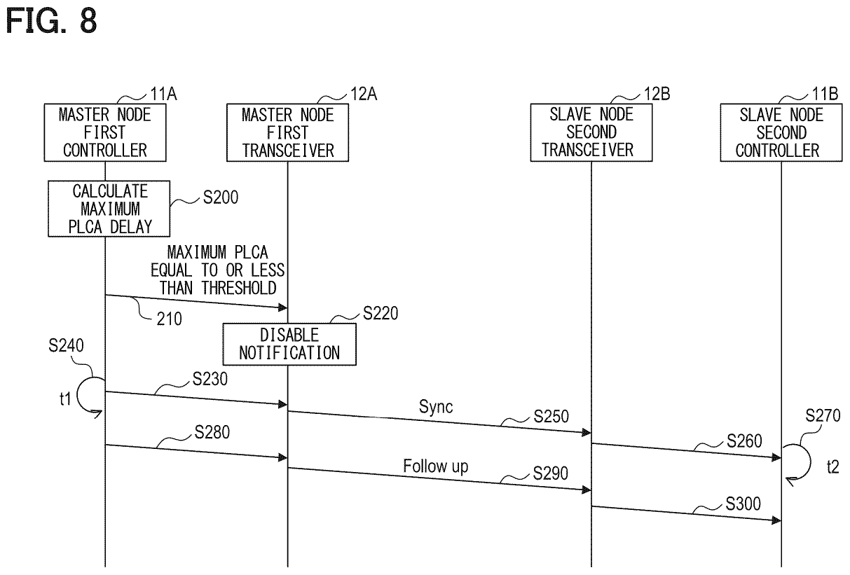

A Sync/Follow-up sequence executed by a node of the bus type network 110A will be described with reference to FIG. 8.

In S200, the delay evaluation unit 113 of the first controller 11A calculates the maximum PLCA delay. When the maximum PLCA delay is greater than the threshold, the master node and the slave node execute processes in S1 to S9 and S10 to S90. When the maximum PLCA delay is equal to or less than the threshold, the first controller 11A proceeds to the process of S210.

In S210, the delay evaluation unit 113 of the first controller 11A notifies the first transceiver 12A that the maximum PLCA delay is equal to or less than the threshold. In S220, the notification unit 123 of the first transceiver 12A disables the notification of the first controller 11A upon receiving notification from the delay evaluation unit 113 that the maximum PLCA delay is equal to or less than the threshold.

In S230, the time synchronization unit 112 of the first controller 11A transmits the Sync frame to the first transceiver 12A at time t1. In S240, the time synchronization unit 112 of the first controller 11A records the time stamp of the time t1.

In S250 to S270, the first transceiver 12A, the second transceiver 12B, and the second controller 11B execute the same processes as in S2 to S4. In S280 to S300, the first controller 11A, the first transceiver 12A, and the second transceiver 12B execute the same processes as in S70 to S90.

Further, in the Pdelay Request/Pdelay Response sequence, the first controller 11A, the first transceiver 12A, the second transceiver 12B, and the second controller 11B execute the same processes as in S10 to S40 and S60 to S90. However, in S60, the second controller 11B records the time stamp of the time t3.

Thereby, the time synchronization unit 112 of the second controller 11B acquires the times t1, t2, t3, and t4. The time synchronization unit 112 of the second controller 11B calculates the time offset Δt and the transmission path delay ΔT based on Δt=((t2−t1)−(t4−t3))/2, ΔT=((t2−t1)+(t4−t3))/2.

### 2-3. Effects

According to the second embodiment described in detail above, the effects (1) to (4) of the first embodiment described above are obtained, and the following effect is further obtained.
(5) When the maximum PLCA delay is equal to or less than the threshold, the difference between the time t1′ and the time t1 and the difference between the time t3′ and the time t3 are sufficiently small. Accordingly, in such a case, even when the slave node calculates the time offset Δt using the times t1 and t3 instead of the times t1′ and t3′, it is possible to maintain sufficient time synchronization accuracy. Therefore, the transceiver 12 can stop the unnecessary notification process and reduce the processing load without reducing the time synchronization accuracy.

### 3. Other Embodiments

Although the embodiment of the present disclosure has been described above, the present disclosure is not limited to the embodiment described above, and various modifications can be made to implement the present disclosure.
(a) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. Part of the configuration of the above embodiment may be omitted. At least a part of the configuration in one embodiment may be added to or substituted for the configuration of another embodiment.

### DESCRIPTION OF REFERENCE NUMERALS

The reference numeral of 11 corresponds to a controller, the reference numeral of 12 corresponds to a transceiver, the reference numeral of 110 corresponds to a first communication line, the reference numeral of 111 corresponds to a time stamp acquisition unit, the reference numerals of 100A, 100B correspond to an in-vehicle communication system, the reference numeral of 112 corresponds to a time synchronization unit, the reference numeral of 113 corresponds to a delay evaluation unit, the reference numeral of 121 corresponds to a transmission reception unit, the reference numeral of 122 corresponds to a time synchronization frame detection unit, the reference numeral of 123 corresponds to a notification unit, and the reference numeral of 124 corresponds to a PLCA unit.

What is claimed is:

1. A communication device in a plurality of nodes connected to an in-vehicle communication line, the communication device comprising:
a controller configured to output a first time synchronization frame; and
a transceiver configured to
transmit the first time synchronization frame output from the controller to the in-vehicle communication line in a physical layer collision avoidance manner, and
notify the controller that the first time synchronization frame has been transmitted.

2. The communication device according to claim 1, wherein
the controller is configured to acquire a time stamp used for time synchronization between the plurality of nodes via the in-vehicle communication line in response to notification that the first time synchronization frame has been transmitted to the transceiver.

3. The communication device according to claim 2, wherein the controller is configured to output a second time synchronization frame storing the acquired time stamp to the transceiver, and the transceiver is configured to transmit the second time synchronization frame output from the controller to the in-vehicle communication line.

4. The communication device according to claim 1, wherein the first time synchronization frame is a sync frame defined by a precision time protocol.

5. The communication device according to claim 1, wherein
the first time synchronization frame is a path delay request frame defined by a precision time protocol.

6. The communication device according to claim 1, wherein
the transceiver stops notifying the controller that the first time synchronization frame has been transmitted when a predetermined condition is satisfied.

7. A time synchronization method executed by a transceiver of a communication device in a plurality of nodes connected to an in-vehicle communication line, the time synchronization method comprising:
receiving a time synchronization frame from a controller of the communication device;
transmitting the time synchronization frame to the in-vehicle communication line in a physical layer collision avoidance manner; and
notifying the controller that the time synchronization frame has been transmitted.

8. A communication system comprising:
a master node and a slave node which are connected to an in-vehicle communication line,
wherein
the master node includes a controller and a transceiver,
the controller is configured to
(i) output a first time synchronization frame to the transceiver,
(ii) acquire a time stamp in response to notification that the transceiver has transmitted the first time synchronization frame, and
(iii) output a second time synchronization frame storing the time stamp to the transceiver,
the transceiver is configured to
(i) transmit the first time synchronization frame output from the controller to the slave node via the in-vehicle communication line in a physical layer collision avoidance manner,
(ii) provide, to the controller, the notification that the transceiver has transmitted the first time synchronization frame, and
(iii) transmit the second time synchronization frame output from the controller to the slave node via the in-vehicle communication line, and
the slave node synchronizes a time of the slave node with a time of the master node based on a time when the slave node receives the first time synchronization frame and the time stamp of the second time synchronization frame.
